(19) United States
(12) Patent Application Publication
(10) Pub. No.: US 2026/0030855 A1
(43) Pub. Date: Jan. 29, 2026

(54) GENERATING PERSPECTIVE DATA FROM ORAL REPRESENTATIONS

(71) Applicant: Get-Grin Inc., Airmont, NY (US)

(72) Inventors: Daniel ANDERSON, Airmont, NY (US); Yarden EILAT-BLOCH, Haifa (IL); Alon Luis LIPNIK, Tel Aviv (IL); Pamela Sharon OREN-ARTZI, Austin, TX (US)

(21) Appl. No.: 19/343,494

(22) Filed: Sep. 29, 2025

Related U.S. Application Data
(63) Continuation of application No. PCT/US24/22399, filed on Mar. 29, 2024.
(60) Provisional application No. 63/455,574, filed on Mar. 30, 2023.

(51) Int. Cl. G06T 19/20; A61C 13/34; G06T 15/20

(52) U.S. Cl. CPC G06T 19/20; A61C 13/34; G06T 15/20; G06T 2200/24; G06T 2210/41; G06T 2219/2016

(57) ABSTRACT

The present disclosure provides methods and system for generating perspective data between two or more oral representations, comprising: presenting a first oral representation and a second oral representation on a digital display, wherein the second oral representation is configured to be manipulated by a user via a user input device; and generating perspective data between the manipulated second oral representation and the first oral representation, wherein the second oral representation is overlaid on the first oral representation such that the first representation is still visible on the digital display.

### CROSS-REFERENCE TO RELATED APPLICATIONS

This application is a continuation of International Patent Application No. PCT/US24/22399, filed Mar. 29, 2024, which claims benefit of U.S. Provisional Application No. 63/455,574, filed Mar. 30, 2023, each of which is incorporated herein by reference in its entirety.

### TECHNICAL FIELD

The present invention, in at least some embodiments, relates to methods and system for dental assessment, and more specifically to methods and system for generating perspective data from oral representations.

### BACKGROUND

Dental professionals may treat and monitor a patient's dental condition based on in-person visits. Treatment and monitoring of a patient's dental condition may require preforming a dental imagining to provide the dentist penetration look of the teeth and jaw's condition. The quality of treatment and the accuracy of monitoring may vary depending on availability of such dental imaging. In some cases, suboptimal treatment outcomes may result if a patient is unable or unwilling to schedule regular visits that can provide dental imaging.

### SUMMARY

Recognized herein is a need for dental monitoring solutions to allow dental assessment, optionally remote dental assessment, without requiring a dental professional to be physically present with the patient. Some dental professionals may use conventional teledentistry solutions to accommodate patients' needs and schedules. However, such conventional teledentistry solutions may provide inadequate levels of supervision. Further, such conventional teledentistry solutions may be limited by an inaccurate or insufficient monitoring of a patient's dental condition based on one or more photos taken by the patient, if the photos do not adequately capture various intraoral features.

The present disclosure provides methods and system for dental assessment, such as remote dental assessment. As used herein, the term “remote dental assessment” may refer to assessments conducted by remote personnel and may refer to the acquisition of one or more intraoral videos and/or intraoral images that can be assessed using a remote computing device or can be sent to different remote locations for assessment. The methods and systems disclosed herein may provide a convenient solution to assess oral treatment progression and user experience for dental assessment presentation, in some embodiments, the methods and system disclosed herein may provide a solution to compare oral representation of a person from different times to get oral progression and ability to train a system to imitate human selections.

In an aspect, provided herein is a method of generating perspective data between two or more oral representations, comprising: providing a digital display, wherein the digital display is configured to receive user input; providing a first oral representation of the two or more oral representations; presenting a second oral representation of the two or more oral representations on the digital display, wherein the second oral representation is configured to be manipulated by a user via a user input device; and generating perspective data between the manipulated second oral representation and the first oral representation, wherein the second oral representation is overlaid on the first oral representation such that the first representation is still visible.

In some cases, the digital display is a computer screen, a mobile device screen, an augmented reality device, a virtual reality environment, or a projection, or any combination thereof. In some cases, the user input device is a keyboard, a pointing device, a touch screen, a touch pad, a gesture, a movement of the user, or a voice command, or any combination thereof. In some cases, the first oral representation is an oral scan, an x-ray, a CT, a digital model, a digital 3D model, a 3D model, an image, a picture, or a drawing. In some cases, the second oral representation is an oral scan, an x-ray, a CT, a digital model, a digital 3D model, an image, a picture, or a drawing. In some cases, the manipulation comprises translating, tilting, zooming, shrinking, rotating, expanding, focusing, changing a field of view, or changing a light source, or any combination thereof. In some cases, the manipulation changes the perspective of the second oral representation from the first oral representation. In some cases, the manipulation comprises matching at least one object in the second oral representation to a corresponding object in the first oral representation. In some cases, the object comprises at least a portion of a tooth, at least a portion of a gum, an intraoral mark, or at least a portion of an intraoral cavity. In some cases, the perspective data comprises a plane of the manipulated second oral representation. In some cases, the perspective data is used for generating 3D representation data from a 2D oral representation. In some cases, the method is used as logic barrier software, a training technique, or a computer game. In some cases, the method further comprises converting the manipulated second oral representation to a digital 3D oral model. In some cases, the first oral representation comprises a series of images, and wherein the second oral representation comprises an initial digital 3D oral model. In some cases, the method further comprises saving the manipulated second oral representation.

In another aspect, provided herein is a system for generating perspective data between two or more oral representations, comprising a non-transitory computer readable storage medium comprising instructions, the instructions configured to perform a method comprising: providing a first oral representation of the two or more oral representations; presenting a second oral representation of the two or more oral representations on the digital display, wherein the second oral representation is configured to be manipulated by a user via a user input device; and generating perspective data between the manipulated second oral representation and the first oral representation, wherein the second oral representation is overlaid on the first oral representation such that the first representation is still visible.

In some cases, the digital display is a computer screen, a mobile device screen, an augmented reality device, a virtual reality environment, or a projection, or any combination thereof.

In some cases, the user input device is a keyboard, a pointing device, a touch screen, a touch pad, a gesture, a movement of the user, or a voice command, or any combination thereof.

In some cases, the first oral representation is an oral scan, an x-ray, a CT, a digital model, a digital 3D model, a 3D model, an image, a picture, or a drawing. In some cases, the second oral representation is an oral scan, an x-ray, a CT, a digital model, a digital 3D model, an image, a picture, or a drawing. In some cases, the manipulation comprises translating, tilting, zooming, shrinking, rotating, expanding, focusing, changing a field of view, or changing a light source, or any combination thereof. In some cases, the manipulation changes the perspective of the second oral representation from the first oral representation. In some cases, the manipulation comprises matching at least one object in the second oral representation to a corresponding object in the first oral representation. In some cases, the object comprises at least a portion of a tooth, at least a portion of a gum, an intraoral mark, or at least a portion of an intraoral cavity. In some cases, the calculating of the perspective comprises a plane of the manipulated second oral representation. In some cases, the perspective data is used for generating 3D representation data from a 2D oral representation. In some cases, the method is used as logic barrier software, a training technique, or a computer game. In some cases, the method further comprises converting the manipulated second oral representation to a digital 3D oral model. In some cases, the first oral representation comprises a series of images, and wherein the second oral representation comprises an initial digital 3D oral model. In some cases, the method further comprises saving the manipulated second oral representation.

In another aspect, provided herein is a method for training a machine learning software to generate perspective data between two or more oral representations, comprising: providing to at least one user the system described above; monitoring the manipulation of the user; and reviewing machine learning software manipulations of the second oral representation in accordance with the monitored manipulations of the user.

In another aspect, provided herein is a method for training a machine learning software to generate perspective data between two or more oral representations, comprising: providing a user at least two tasks, wherein a task comprises providing a first oral representation of the two or more oral representations, presenting a second oral representation of the two or more oral representations on a digital display, wherein the second oral representation is configured to be manipulated by a user via a user input device, and saving a manipulation of the second oral representation by the user; and using the machine learning software to run a software manipulation of the second oral representation based on the saved manipulations of the at least two tasks.

In some cases, the digital display is a computer screen, a mobile device screen, an augmented reality device, a virtual reality environment, or a projection, or any combination thereof. In some cases, the user input device is a keyboard, a pointing device, a touch screen, a touch pad, a gesture, a movement of the user, or a voice command, or any combination thereof. In some cases, the first oral representation is an oral scan, an x-ray, a CT, a digital model, a digital 3D model, a 3D model, an image, a picture, or a drawing. In some cases, the second oral representation is an oral scan, an x-ray, a CT, a digital model, a digital 3D model, an image, a picture, or a drawing. In some cases, the manipulation comprises translating, tilting, zooming, shrinking, rotating, expanding, focusing, changing a field of view, or changing a light source, or any combination thereof. In some cases, the manipulation changes the perspective of the second oral representation from the first oral representation. In some cases, the manipulation comprises matching at least one object in the second oral representation to a corresponding object in the first oral representation. In some cases, the object comprises at least a portion of a tooth, at least a portion of a gum, an intraoral mark, or at least a portion of an intraoral cavity. In some cases, the machine learning software is a generative artificial intelligence or an equivalent thereof. In some cases, the review is conducted by a machine learning software or artificial intelligence (AI).

A system for generating perspective data between two or more oral representations, comprising a non-transitory computer readable storage medium comprising instructions, the instructions configured to perform a method comprising: presenting a first oral representation of the two or more digital representations; presenting a second oral representation of the two or more oral representations on a digital display, wherein the second oral representation is configured to be manipulated by one or more users via a user input device; receiving manipulation data from the one or more users for similar tasks; based on the manipulation data from the one or more users, manipulating the second oral representation to match the first oral representation; and providing perspective data between the first oral representation and the manipulated second oral representation.

In some cases, the digital display is a computer screen, a mobile device screen, an augmented reality device, a virtual reality environment, or a projection, or any combination thereof. In some cases, the user input device is a keyboard, a pointing device, a touch screen, a touch pad, a gesture, a movement of the user, or a voice command, or any combination thereof. In some cases, the first oral representation is an oral scan, an x-ray, a CT, a digital model, a digital 3D model, an image, a picture, or a drawing. In some cases, the second oral representation is an oral scan, an x-ray, a CT, a digital model, a digital 3D model, a 3D model, an image, a picture, or a drawing. In some cases, the manipulation comprises translating, tilting, zooming, shrinking, rotating, expanding, focusing, changing a field of view, or changing a light source, or any combination thereof. In some cases, the manipulation changes the perspective of the second oral representation from the first oral representation. In some cases, the manipulation comprises matching at least one object in the second oral representation to a corresponding object in the first oral representation. In some cases, the object comprises at least a portion of a tooth, at least a portion of a gum, an intraoral mark, or at least a portion of an intraoral cavity. In some cases, a user can feedback the manipulation, thereby changing the manipulation of the system of the second oral representation.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system of the present invention involves performing or completing selected tasks or steps manually, automatically, or a combination thereof. Moreover, according to actual instrumentation and equipment of preferred embodiments of methods, apparatus and systems of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

In order to understand the invention and to see how it may be carried out in practice, embodiments will now be described, by way of non-limiting examples only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a flow-chart schematically illustrating methods to generate perspective data between two oral representations, in accordance with the principles described herein.

FIG. 2 schematically illustrates a method for perspective data between two oral representations, in accordance with the principles described herein.

FIGS. 3A-3G are example screenshots from a system that, among other, presents oral representations, in accordance with the principles described herein.

FIG. 4 schematically illustrates a computer system that is programmed or otherwise configured to implement at least some of the methods disclosed herein, in accordance with the principles described herein.

FIG. 5 is a flow-chart schematically illustrating a method to train a machine learning software to generate perspective data between two oral representations, in accordance with the principles described herein.

FIG. 6 is a flow-chart schematically illustrating a method to train a machine learning software to generate perspective data between two oral representations, in accordance with the principles described herein.

FIG. 7 is a flow-chart schematically illustrating a system to generate perspective data between two oral representations, in accordance with the principles described herein.

### DETAILED DESCRIPTION OF EMBODIMENTS

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “real-time,” as used herein, generally refers to a simultaneous or substantially simultaneous occurrence of a first event or action with respect to an occurrence of a second event or action. A real-time action or event may be performed within a response time of less than one or more of the following: ten seconds, five seconds, one second, a tenth of a second, a hundredth of a second, a millisecond, or less relative to at least another event or action. A real-time action may be performed by one or more computer processors.

As used herein, when a numerical value is preceded by the term “about”, the term “about” is intended to indicate +/−10% of that value. Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The terms “a,” “an,” and “the,” as used herein, generally refer to singular and plural references unless the context clearly dictates otherwise.

### Overview

According to an aspect, the present disclosure provides methods and systems for intraoral assessment. As used herein, “intraoral assessment” may refer to assessment of an appearance or condition of an intraoral region of a subject. The methods and system disclosed herein may provide a convenient presentation of an intraoral assessment such as teeth morphology that include all aspects acquired by the dental scan. The methods and systems disclosed herein may provide dentists and orthodontists or any health care personal with a detailed analysis of the patient's dental condition based on a video or on one or more images of at least one tooth, such as one or more teeth, one or more dental arches or both dental arches of a subject, in some embodiments captured remotely by a user, In some embodiments, the user is the subject. In some embodiments the user is a person other than the subject, present at the same location as the subject and assessment of the captured video or image(s) is performed at a remote location.

As used herein the term “dental scope” or “dental adaptor” generally refers to a device that can be attached to a camera or mobile phone comprising a camera and enables capturing at least one intraoral image or videos of a subject. The term “dental scope” or “dental adaptor” may refer to a hollow tubular adapter wherein one opening of the hollow tubular adapter is attached to the mobile digital camera and the second opening of the hollow tubular adapter was in contact with the user inner lips and the lips lay on the outer of the second opening of the hollow tubular adapter. An example and possible uses can be seen in U.S. patent application Ser. No. 17/336,997.

As used herein, the term “dental scan” generally refers to intraoral videos or intraoral images, or oral video, or oral images that are the results of using the “dental scope” or “dental adaptor” as attached to a digital camera such as mobile device while acquiring an intraoral video or intraoral image. An example for dental scan, and possible uses, can be seen in U.S. patent application Ser. No. 17/336,997. The intraoral videos or intraoral images or the dental scan provided to the method and systems of the present disclosure may be implemented using a software application that is configured to enable a dental patient to capture videos and/or images of intraoral regions. The software application may be used by a user or a subject (e.g., a dental patient) in conjunction with a mobile device to remotely monitor a dental condition of the subject. The dental condition may comprise a development, a growth, a movement, an appearance, a condition, a physical arrangement, a position, and/or an orientation of the subject's teeth or/and the subject's soft tissues in the oral cavity.

As used herein, “remote monitoring” may refer to monitoring the intraoral region of a subject and/or a condition of an intraoral region of a subject, wherein the monitoring is performed at one or more locations remote from the subject. For example, a dentist or a medical specialist may monitor the intraoral anatomy or intraoral condition at a first location that is different than a second location at which the subject is located. The first location and the second location may be separated by a distance spanning at least 1 meter, 1 kilometer, 10 kilometers, 100 kilometers, 1000 kilometers, or more.

The remote monitoring may be performed by assessing an intraoral condition of the subject using one or more dental scans captured from the subject when the subject is located remotely from the dentist or a dental office. In some cases, the remote monitoring may be performed in real-time such that a dentist is able to assess the dental condition when a subject uses a mobile device to acquire one or more videos or images of one or more intraoral regions in the patient's mouth. The remote monitoring may be performed using equipment, hardware, and/or software that is not physically located at a dental office.

The software application for dental assessment may be configured to run on a mobile device. The mobile device may comprise a smartphone, a tablet, a laptop, or any suitable device that may be used by a patient to capture one or more dental assessments. The software application may be installed on a mobile device of a user. The software application may be a patient-side software application. Alternatively, the software application for dental assessment may be configured to run on a fixed-location device, such as a desktop computer. Alternatively, the software application for dental assessment may be configured to run on a remote location device, such as a compute cloud server or service.

The methods and systems disclosed herein may provide a convenient solution to assess oral treatment progression and user experience for dental assessment presentation, in some embodiments, the methods and system disclosed herein may provide a solution to compare oral representation of a person from different times to get oral progression and ability to train a system to imitate human selections.

As used herein, the terms “oral representation”, refer to a digital or physical presentation of the oral cavity, including dental scan images or videos, including medical or non-medical imaging that can acquire hard tissue theurge soft tissues, such as X-ray, magnetic resonance imaging (MRI), computed tomography (CT), transillumination, and fluorescent imaging, including digital or physical 3d model of the oral cavity.

As used herein, the term “user selection” refer to a specific alignment of two oral representation that according to the user provide the bast match of object or objects that appear in the oral representations. The object can be a part of a tooth, full tooth, part of teeth, part of a gum, mark, or any part of intra oral cavity.

### Methods Generate Perspective Data Between Two Oral Representations.

According to an aspect described herein is a method to generate perspective data between two oral representations, comprising:
providing a digital display and an ability to receive user input;
providing first oral representation;
providing second oral representation;
presenting the first oral representation and the second oral representation, at least one of them on a digital display;
enabling the user to manipulate the second oral representation, to get user selection;
calculating the perspective between the manipulated second oral representation and the first oral representation;
wherein the second oral representation is presented in a way that the first representation is visible.

As used herein, the term “perspective” or “perspective data” refer to a position that from which the oral presentation acquired. Manipulation of an oral representation change the perspective of the oral representation and the virtual position that from which the oral representation would been acquired to gain the manipulated oral representation.

According to some embodiments, the digital display is computer screen, mobile device screen, augmented reality device, virtual reality environment, and projection.

According to some embodiments, the user input device is a keyboard, a pointing device, a touch screen, a touch pad, a gesture, user movement, or a voice command. According to some embodiments, the pointing device can be a computer mouse, a tracking ball, TrackPoint, a 3D mouse, an eye tracker, a 3D position tracker or others.

According to some embodiments, the first oral representation is an oral scan, an x-ray, a CT, a digital model, a digital 3D model, a 3D model, an image, a picture, or a drawing, or any combination thereof.

According to some embodiments, the second oral representation is an oral scan, an x-ray, a CT, a digital model, a digital 3D model, an image, a picture, or a drawing, or any combination thereof.

According to some embodiments, the manipulation include tilt, zoom, shrink, rotate, expand, focus, changing field of view, changing light source. According to some embodiments, the manipulation can be applied on one axis of the second oral representation. According to some embodiments, the manipulation can be applied on all axis of the second oral representation, According to some embodiments, a manipulation applied on one axis affect other axis. According to some embodiments, changing light source include the intensity, color, or location of the light source of the original oral representation.

According to some embodiments, the manipulation can change the perspective of the second oral representation from the first oral representation.

According to some embodiments, user selection can include matching of at least one object in the second oral representation to object in the first oral representation.

According to some preferred embodiments, the object is a part of a tooth, part of a gum, mark, or any part of intraoral cavity.

According to some embodiments, the calculating the perspective comprises the manipulated second oral representation plane.

According to some embodiments, the generated perspective data is used for 3D representation data from a 2D oral representation.

According to some embodiments, the method is use as logic barrier software, a training technique, or a computer game.

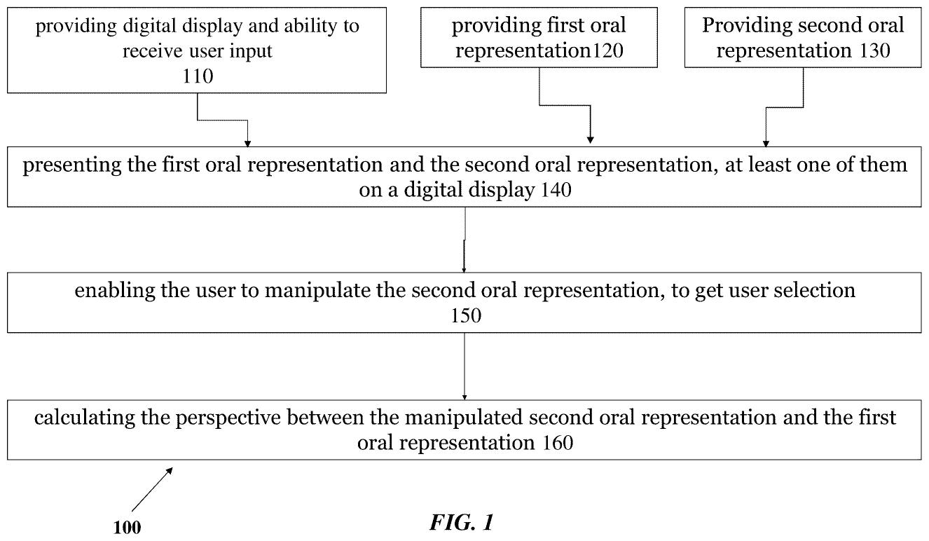

FIG. 1 schematically illustrates a method 100 to generate perspective data between two oral representations, in accordance with the principles of some embodiments described herein. The method can include: (a) providing a digital display and an ability to receive user input 110, (b) providing first oral representation 120, (c) providing second oral representation 120, (d) presenting 140 the first oral representation 110 and the second oral representation 120, at least one of them on a digital display 130, (e) enabling the user to manipulate the second oral representation, to get user selection 150; and (f) calculating 160 the perspective between the manipulated second oral representation and the first oral representation.

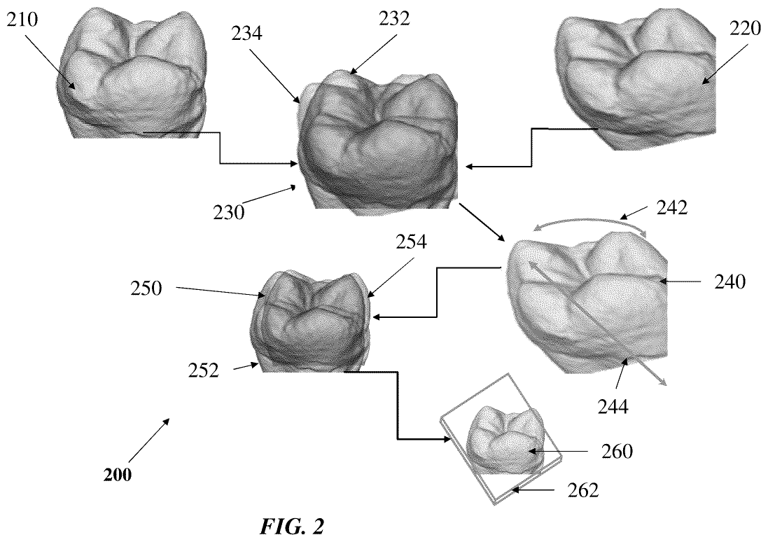

FIG. 2 schematically illustrates a method for generating perspective data between two oral representations 200, in accordance with the principles of some embodiments described herein. In some cases, the method includes providing a first oral representation 210 and providing a second oral representation 220. In some cases, the second oral representation 234 is presented over the first oral representation 232 in a way that the first representation 234 is visible. In some cases, the method comprises manipulating 240 the second oral representation 234. In this specific example the manipulation include rotation 242 of the second representation to the left and contraction 244 the diagonal bottom right and the upper left of the second representation to get to the match 250 of the manipulated second representation 254 to the first oral representation 252. The first oral representation didn't change during the process: 210, 232 and 252 are identical. The second oral representation 220 has been changed to partially-transparent 234 and then manipulated 244 to 254 during the method. Once the second oral representation has been manipulated and fitted to user selection oral representation 260, it can be used to calculate the updated perspective using the plane 262 generated from the manipulation 240. According to an aspect of some embodiments, the manipulation 240 can be conducted using a user input device. According to some embodiments, the input device can be a keyboard, pointing device, touch screen, touch pad, gesture, user movement, or a voice command.

According to an aspect of some embodiments described herein, there is provided a method to train a machine learning software to generate perspective data between two oral representations, comprising: providing to at least one user the system according to describe herein above; providing first and second oral representation; monitoring user manipulations; review machine learning software manipulations of the second oral representation in accordance to the monitored user manipulation.

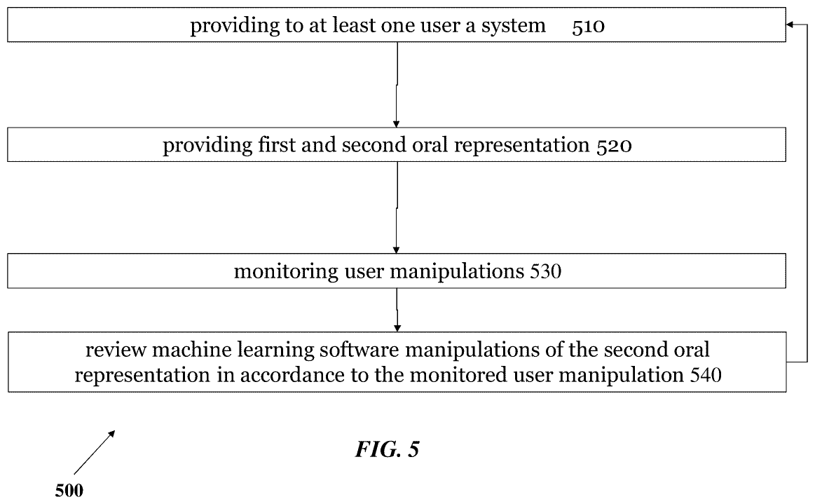

FIG. 5 is a flow-chart schematically illustrating method 500 to train a machine learning software to generate perspective data between two oral representations, in accordance with the principles of some embodiments described herein. Another aspect provided herein is a method to train a machine learning software to generate perspective data between two oral representations, comprising: providing 510 to at least one user the system according to describe herein above; providing first and second oral representation 520; monitoring user manipulations 530; and review machine learning software manipulations of the second oral representation in accordance to the monitored user manipulation 540.

### System for Generating Perspective Data Between Two Oral Representations.

According to an aspect of some embodiments described herein, there is provided a system to generate perspective data between two oral representations, comprising:
a processor; a storage element connected to the processor; encoded instruction stored in the storage element, a digital display and an ability to receive user input, wherein the encoded instructions when implemented by the processor, configure the system to:
perception presentation or receive a first oral representation;
receive a second oral representation;
present the first oral representation and the second oral representation, at least one of them on a digital display;
receive user manipulation of the second oral representation, to get user selection;
calculate the perspective between the manipulated second oral representation and the first oral representation;
wherein the second oral representation is presented in a way that the first representation is visible.

According to some embodiments, the digital display is a computer screen, a mobile device screen, an augmented reality device, a virtual reality environment, or a projection, or any combination thereof.

According to some embodiments, the first oral representation is an oral scan, an x-ray, a CT, a digital model, a digital 3D model, a 3D model, an image, a picture, or a drawing, or a combination thereof.

According to some embodiments, the second oral representation is an oral scan, an x-ray, a CT, a digital model, a digital 3D model, a picture, or a drawing, or a combination thereof.

According to some embodiments, the manipulation includes tilt, zoom, shrink, rotate, expand, focus, changing field of view, or changing light source, or any combination thereof.

According to some embodiments, the manipulation includes tilt, zoom, shrink, rotate, expand, focus, changing field of view, changing light source.

According to some embodiments, the manipulation changes the perspective of the second oral representation from the first oral representation.

According to some embodiments, the user selection includes matching to at least one object in the second oral representation to object in the first oral representation.

According to some preferred embodiments, the object is a part of a tooth, part of a gum, a mark, or any part of an intraoral cavity.

According to some embodiments, the calculate the perspective comprise the manipulated second oral representation plane.

According to some embodiments, the system can be used to generate 3D data from a 2D oral representation.

According to some embodiments, the system can be used as logic barrier software, a training technique, or a computer game.

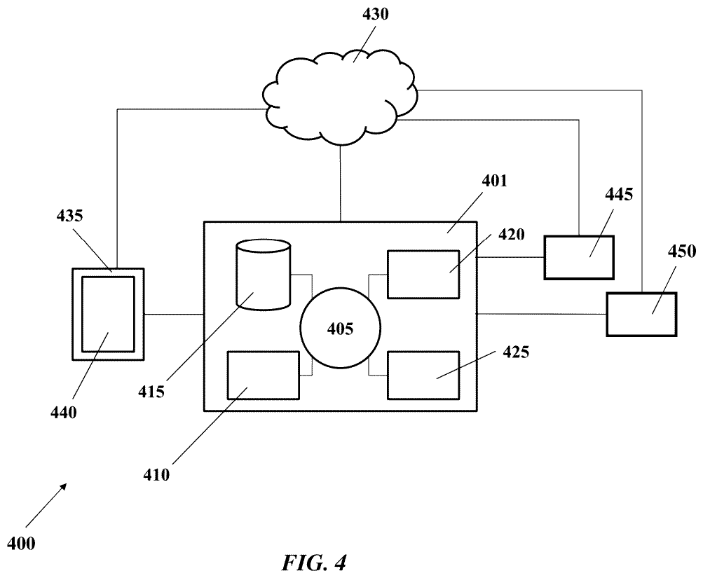

FIG. 4 shows a computer system 401 that is programmed or otherwise configured to implement a method to generate perspective data between two oral representations. The computer system 401 may be configured to, for example, process intraoral videos or images captured using the camera of a mobile device, and presenting the oral representations. The computer system 401 can be an electronic device of a user or a computer system that is remotely located with respect to the electronic device, or even in the cloud. The electronic device can be a mobile electronic device. The computer system 401 can be a smartphone.

The computer system 401 may include a central processing unit (CPU, also “processor” and “computer processor” herein) 405, which can be a single core or multi core processor, or a plurality of processors for parallel processing. The computer system 401 also includes memory or memory location 410 (e.g., random-access memory, read-only memory, flash memory), electronic storage unit 415 (e.g., hard disk, Solid State drive or equivalent storge unit), communication interface 420 (e.g., network adaptor) for communicating with one or more other systems, and peripheral devices 425, such as cache, other memory, data storage and/or electronic display adaptors. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are located external to the computer system 401 (e.g., on a remote server that is in communication with the computer system 401 through an intranet or the Internet).

The computer system 401 can communicate with one or more remote computer systems through the network 430. For instance, the computer system 401 can communicate with a remote computer system of a user (e.g., a subject, a dental patient, or a dentist). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 401 via the network 430.

Methods and systems as described herein can be implemented by way of machine (e.g., computer processor) executable code stored on an electronic storage location of the computer system 401, such as, for example, on the memory 410 or electronic storage unit 415. The machine executable or machine readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a storage unit. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display 435 that comprises a user interface (UI) 440 for providing, for example, a portal for a subject or a user to view one or more intraoral images or videos captured using a mobile device of the subject or the user. In some cases, the electronic display 435 may be the feedback element providing the generated output, for example displaying message or shape or light in accordance to some embodiments. The portal may be provided through an application programming interface (API). A user or entity can also interact with various elements in the portal via the UI. Examples of UI's include, without limitation, a graphical user interface (GUI) and web-based user interface.

The computer system 401 can include or be in communication with a camera 445 for providing, for example, ability to capture videos or images of the intraoral of a user. Methods and systems of the present disclosure can be implemented by way of one or more algorithms. An algorithm can be implemented by way of software upon execution by the central processing unit 405. The algorithm can, for example, implement a method for presenting teeth morphology. The method may comprise processing videos or images captured using the camera of the mobile device or processing received user oral video or oral images and/or received user dental imaging image and executed to generate output.

The algorithm can, for example, implement a method of machine learning framework to generate perspective data between two oral representations. In order to transfer a given capability into a machine, so-called supervised machine-learning techniques can be employed. Broadly speaking, a training dataset containing input images together with requested output (the “ground-truth”) is assembled. This dataset is assembled from input images which should resemble the expected input images to the machine after deployment as much as possible. The requested output can be any desired output type, e.g image classification, segmentation mask, image augmentation, text etc. The requested output can be gathered by manual human labeling, or by fusing data with other means of data gathering.

This dataset is then fed into a machine-learning framework which uses an optimization process to control internal parameters in a model architecture (e.g SVM, neural network, random forest etc.). The optimization process goal is to reduce the error between the machine's output and the ground-truth output for each image in the training dataset. Once the optimization process has reached the required accuracy on the training dataset the machine's performance can be tested on a similar test dataset to validate the performance in real-world settings.

According to an aspect of some embodiments of the present invention, there is provided a system 401 to generate perspective data between two oral representations, comprising:
a processor 405; a storage element 415 connected to the processor 405; encoded instruction stored in the storage element 415, a digital display 435 and an ability to receive user input 440, wherein the encoded instructions when implemented by the processor 405, configure the system 401 to:
perception presentation or receive first oral representation;
receive second oral representation;
present the first oral representation and the second oral representation, at least one of them on a digital display 435;
receive user manipulation on 440 of the second oral representation, to get user selection;
calculate on 405 the perspective between the manipulated second oral representation and the first oral representation;
wherein the second oral representation is presented in a way that the first representation is visible.

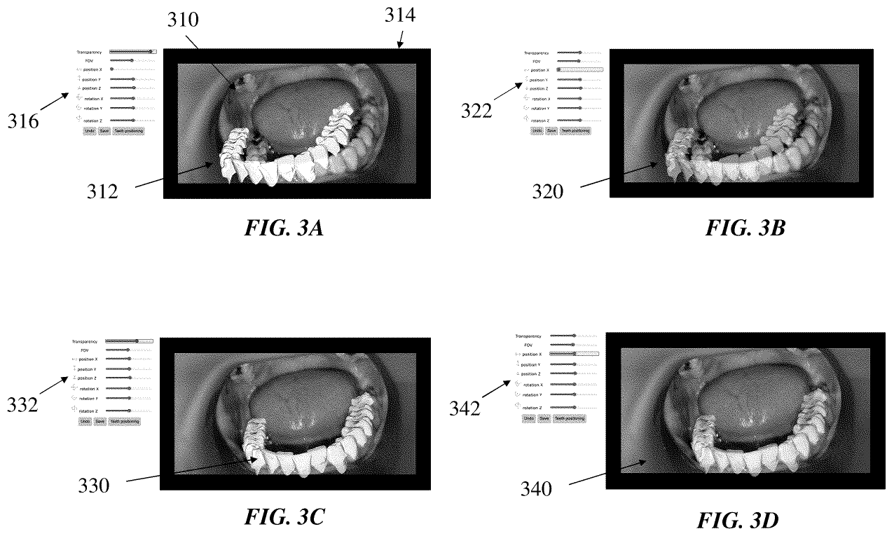

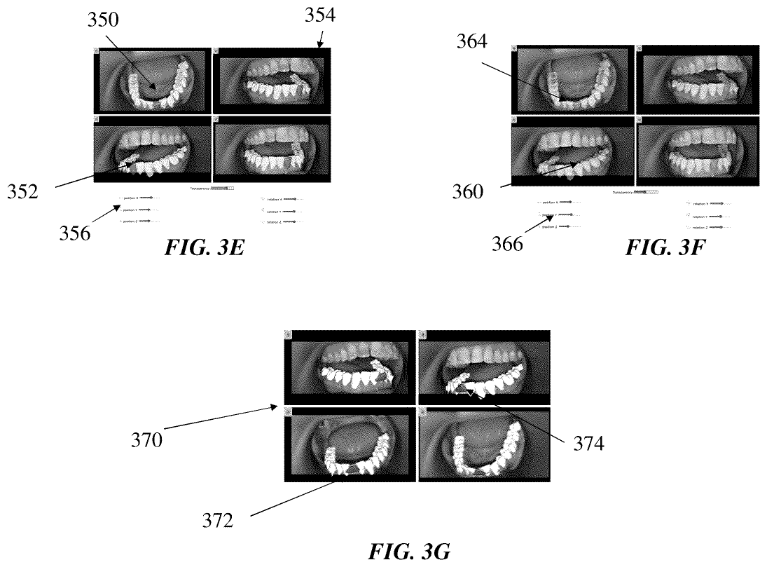

FIGS. 3A-3D are example screenshots from a system that, among other, presents oral representations, in accordance with the principles of some embodiments described herein. The example in FIG. 3A to 3D shows a manipulation process to match two oral representations.

FIG. 3A is a screenshot of a system according to some embodiments described herein. On the display 314, the first oral representation 310 is a frame from a dental scan. The second oral representation 312 can be a 3D model of the same user. Control bar 316 can allow a user to manipulate the second oral representation 312.

FIG. 3B is a screenshot of a system according to some embodiments described herein, with the same oral representation of FIG. 3A. Control bar 322 can allow a user to manipulate the second oral representation 320 to change the transparency of the second oral representation 320.

FIG. 3C is a screenshot of a system according to some embodiments described herein, with the same oral representation of FIG. 3A and FIG. 3B. Control bar 332 can allow a user to manipulate the second oral representation 330 to fit second oral representation 330 to overlay on the first oral representation.

FIG. 3D is a screenshot of a system according to some embodiments described herein, with the same oral representation of FIG. 3A, FIG. 3B and FIG. 3C. Control bar 342 can allow a user to manipulate the second oral representation 340 to match second oral representation 340 to fit the first oral representation.

FIGS. 3E-3G are example screenshots from a system that, among other, presents oral representations, in accordance with the principles described herein. The examples in FIG. 3E to 3F show a manipulation process to match individual teeth or an individual tooth from two oral representations.

FIG. 3E is a screenshot of a system according to an embodiment described herein. The display 354 of the first oral representation 350 can be a frame from a dental scan. The second oral representation 352 can be a 3D model of the same user. The desired teeth is colored differently. Control bar 356 can allow a user to manipulate the desired teeth of the second oral representation 352.

FIG. 3F is a screenshot of a system according to an embodiment described herein, with the same oral representation of FIG. 3E. Control bar 360 can allow a user to manipulate the second oral representation 364 to change the transparency and to fit over the first oral representation 360.

FIG. 3G is a screenshot 370 of a system according to an embodiment described herein, with the same oral representation of FIG. 3E and FIG. 3F. Manipulated second oral representation 372, 374 are matched over the first oral representation at different perspectives.

### Methods and Systems for Software to Generate Perspective Data Between Two Oral Representations.

Another aspect provided herein is a method to train a machine learning software to generate perspective data between two oral representations, comprising: providing users a task, comprising: presenting a first oral representation and a second oral representation, at least one of them on a digital display; and enabling the users to manipulate the second oral representation with user input device, to get user selection, while monitoring users manipulations; enabling the machine learning software to run in accordance of at least two tasks; and reviewing machine learning software manipulations of the second oral representations in accordance to the saved users manipulation.

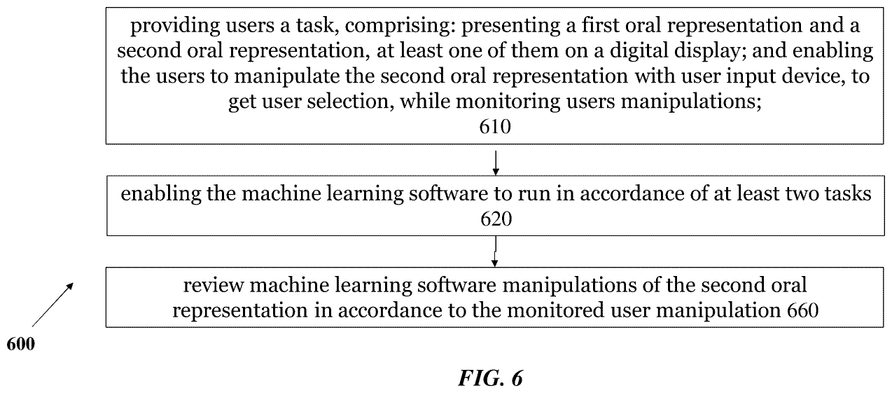

FIG. 6 is a flow-chart schematically illustrating a method 600 to train a machine learning software to generate perspective data between two oral representations, comprising: providing users a task, comprising: presenting a first oral representation and a second oral representation, at least one of them on a digital display; and enabling the users to manipulate the second oral representation with user input device, to get user selection, while monitoring users manipulations 610; enabling 620 the machine learning software to run in accordance of at least two tasks; and reviewing 630 machine learning software manipulations of the second oral representations in accordance to the saved users manipulation.

According to some embodiments, the first oral representation is an oral scan, an x-ray, a CT, a digital model, a digital 3D model, a 3D model, an image, a picture, or a drawing, or a combination thereof.

According to some embodiments, the second oral representation is an oral scan, an x-ray, a CT, a digital model, a digital 3D model, a picture, or a drawing, or a combination thereof.

According to some embodiments, the manipulation includes tilt, zoom, shrink, rotate, expand, focus, changing field of view, or changing light source, or any combination thereof.

According to some embodiments, the manipulation changes the perspective of the second oral representation from the first oral representation.

According to some embodiments, user selection includes matching of at least one object in the second oral representation to object in the first oral representation.

According to some preferred embodiments, the object is a part of a tooth, part of a gum, mark, or any part of intraoral cavity.

According to some embodiments, the machine learning software is generative artificial intelligence or equivalent.

According to some embodiments, the review is conducted by a machine learning software or AI.

According to an aspect described herein, there is provided a system to generate perspective data between two oral representations, comprising: a processor; a storage element connected to the processor; encoded instruction stored in the storage element, a digital display and an ability to receive user input, wherein the encoded instructions when implemented by the processor, configure the system to: receive first oral representation; receive second oral representation; receive data on users manipulation to get user selection, for similar tasks; manipulate the second oral representation to match the first oral representation; provide perspective data between two oral representations.

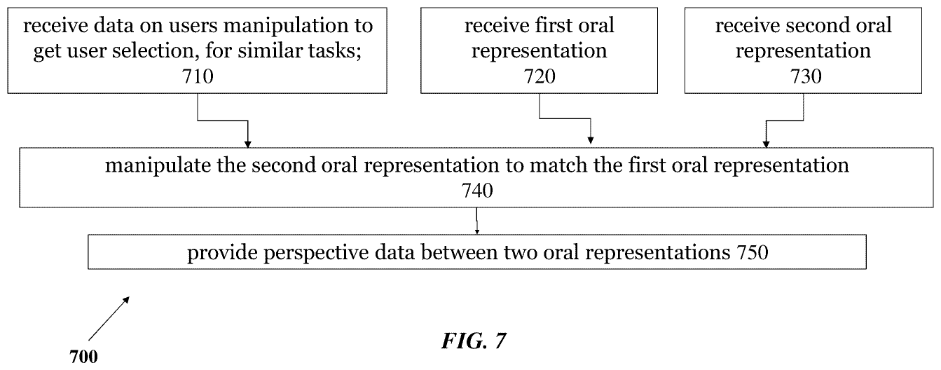

FIG. 7 is a flow-chart schematically illustrating a system 700 to generate perspective data between two oral representations. The system 700 can receive a first oral representation 720. The system 700 can receive a second oral representation 730. In some cases, the system receives data on users manipulation to get user selection, for similar tasks 710. In some cases, the system manipulates the second oral representation to match the first oral representation 740 and provides perspective data between two oral representations 750.

According to some embodiments, the first oral representation is an oral scan, an x-ray, a CT, a digital model, a digital 3D model, a 3D model, an image, a picture, or a drawing, or a combination thereof.

According to some embodiments, the second oral representation is an oral scan, an x-ray, a CT, a digital model, a digital 3D model, a picture, or a drawing, or a combination thereof.

According to some embodiments, the manipulation includes tilt, zoom, shrink, rotate, expand, focus, changing field of view, or changing light source, or any combination thereof.

According to some embodiments, the manipulation changes the perspective of the second oral representation from the first oral representation.

According to some embodiments, user selection includes the matching of at least one object in the second oral representation to an object in the first oral representation.

According to some embodiments, the object is a part of a tooth, part of a gum, mark, or any part of intra oral cavity.

According to some embodiments, the manipulation is presented to a user.

According to some embodiments, the user can feedback the manipulation, to change system manipulation.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the mentioned specification, the descriptions and illustrations of the embodiments herein are not meant to be construed in a limiting sense.

Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method of generating perspective data between two or more oral representations, comprising:
providing a digital display connected to a computing device, wherein the digital display or the computing device is configured to receive user input;
providing a first oral representation of the two or more oral representations; providing a second oral representation of the two or more oral representations; presenting the second oral representation of the two or more oral representations on the digital display, wherein the second oral representation is configured to be manipulated by a user via a user input device; and
generating perspective data between the manipulated second oral representation and the first oral representation, wherein the second oral representation is overlaid on the first oral representation such that the first representation is still visible.

2. The method of claim 1, wherein the digital display is a computer screen, a mobile device screen, an augmented reality device, a virtual reality environment, or a projection, or any combination thereof.

3. The method of claim 1, wherein the user input device is a keyboard, a pointing device, a touch screen, a touch pad, a gesture, a movement of the user, or a voice command, or any combination thereof.

4. The method of claim 1, wherein the first oral representation and the second oral representation are each separately either an oral scan, an x-ray, a CT, a digital model, a digital 3D model, a 3D model, an image, a picture, or a drawing.

5. The method of claim 1, wherein the manipulation comprises translating, tilting, zooming, shrinking, rotating, expanding, focusing, changing a field of view, or changing a light source, or any combination thereof.

6. The method of claim 1, wherein the manipulation comprises matching at least one object in the second oral representation to a corresponding object in the first oral representation.

7. The method of claim 6, wherein the object comprises at least a portion of a tooth, at least a portion of a gum, an intraoral mark, or at least a portion of an intraoral cavity.

8. The method of claim 1, wherein the perspective data comprises a plane of the manipulated second oral representation.

9. The method of claim 1, wherein the perspective data is used for generating 3D representation data from a 2D oral representation.

10. The method of claim 1, wherein the method is used as logic barrier software, a training technique, or a computer game.

11. A method for training a machine learning software to generate perspective data between two or more oral representations, comprising:
(a) providing a user at least two tasks, wherein a task of the at least two tasks comprises generating perspective data between two or more oral representations according to the method of claim 1, thereby obtaining a saved manipulation; and
(b) using a machine learning software to run a software manipulation of the second oral representation based on the saved manipulations of the at least two tasks.

12. A system for generating perspective data between two or more oral representations, comprising a non-transitory computer readable storage medium comprising instructions, the instructions configured to perform a method comprising:
presenting a first oral representation of the two or more digital representations; presenting a second oral representation of the two or more oral representations on a digital display, wherein the second oral representation is configured to be manipulated;
receiving manipulation data from one or more users for similar tasks;
based on the manipulation data from the one or more users, manipulating the second oral representation to match the first oral representation; and
providing perspective data between the first oral representation and the manipulated second oral representation.

13. The method of claim 1, further comprising converting the manipulated second oral representation to a digital 3D oral model.

14. The method of claim 13, wherein the first oral representation comprises a series of images, and wherein the second oral representation comprises an initial digital 3D oral model.

15. A system for generating perspective data between two or more oral representations, comprising a non-transitory computer readable storage medium comprising instructions, the instructions configured to perform the method according to claim 1.
